(19) United States
(12) Patent Application Publication
(10) Pub. No.: US 2025/0037082 A1
(43) Pub. Date: Jan. 30, 2025

(54) MACHINE ENGINE ANALYSIS OF NETWORK INTERACTION DATA FOR IDENTIFICATION OF CONFLICTS

(71) Applicant: BANK OF AMERICA CORPORATION, Charlotte, NC (US)

(72) Inventors: Srinath S. Chakravarty, Plano, TX (US); Aravind Shankaragouda Singtalur, McKinney, TX (US); Kenneth L. Boyd, Mechanicsville, VA (US); Kerry M. Vaughan, Lawrenceville, NJ (US); Manmohan V. Datla, Frisco, TX (US); Petar Evan Puskarich, Murphy, TX (US); Stephen Richard Belton, Garden City, NY (US); Steven Nathan Greene, Scarsdale, NY (US); Dinesh Kumar Agrawal, Rowlett, TX (US)

(73) Assignee: BANK OF AMERICA CORPORATION, Charlotte, NC (US)

(21) Appl. No.: 18/227,517

(22) Filed: Jul. 28, 2023

(51) Int. Cl. G06Q 10/1053; G06Q 10/0635

(52) U.S. Cl. CPC G06Q 10/1053; G06Q 10/0635

(57) ABSTRACT

The present disclosure details systems, computer program products, and methods for machine engine analysis of network interaction data to identify conflicts. This involves the activation of an intelligence engine that connects to a backend data engine to access a database of conflict of interest (COI) datasets. The intelligence engine analyzes incoming applicant data and the COI datasets to identify potential conflicts. The identified conflicts are validated using stochastic metrics via a rules engine. A quantifiable probability metric is calculated, representing the probability of conflict from both organizational and individual perspectives. Based on the potential conflict of interest, a recommendation is generated that aligns with the calculated probability. The system then provides recommendations via API or on a user interface that is communicatively coupled to the processor.

### TECHNOLOGICAL FIELD

Example embodiments of the present disclosure relate to machine engine analysis of network interaction data for identification of conflicts.

### BACKGROUND

At present, large entities may not possess a comprehensive system for mapping probabilities and assessing the impact of conflicts of interest (COI) or undisclosed relationships with applicants or potential employees during initial verification. This deficiency can potentially lead to negative outcomes for both the organization and the individuals involved. The proposed solution involves leveraging data from individual applicants and cross-referencing it against various relationship probability areas. The system would then generate recommendations, using confidence and probability metrics derived from intelligent analyses of the applicant's background against extensive existing COI datasets within the entity. The goal would be to guide entities based on this comprehensive probability analysis. This system would not only benefit the organization but also the applicants by safeguarding collected data via use of industry leading data storage and transmission security standards.

Applicant has identified a number of deficiencies and problems associated with machine engine analysis of network interaction data for identification of conflicts. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for machine engine analysis of network interaction data for identification of conflicts.

The present invention includes a uniquely designed intelligent engine which connects to backend data engines to facilitate analysis of incoming and outgoing data in order to perform specific analyses. When considering one or more applicants, potential vendors, partners, employees, or investors, entities may utilize the present invention, and in particular, the Conflict of Interest (COI) solution to assess various relationship domains using a probability and impact-based approach. The invention's rules engine, matches applicant data with a comprehensive set of potential conflicts of interest sourced from available intelligence. It then confirms these matches using stochastic metrics to recommend the course of action with the least associated probability, from both an organizational and individual perspective. These results are provided to via API or displayed on a user interface for transparency. Over time, the system intelligently adapts to emerging conflicts of interest and keeps pace with the constantly evolving applicant pools and business conditions of employers.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for machine engine analysis of network interaction data for identification of conflicts, in accordance with an embodiment of the disclosure;

FIG. 2 illustrates an exemplary machine learning (ML) subsystem architecture 200, in accordance with an embodiment of the invention;

FIG. 3 illustrates a process flow for machine engine analysis of network interaction data for identification of conflicts, in accordance with an embodiment of the disclosure; and

FIG. 4 illustrates a process flow for machine engine analysis of network interaction data for identification of conflicts, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

The system presented herein typically utilizes a programming language such as Python, which is robust and well-suited for data analysis and machine learning applications. In some embodiments, a Python-based server, for instance, Flask or Django, would serve as the main application layer of the system. This server is responsible for handling incoming requests, interfacing with the data storage, and serving responses. In some embodiments, the communication interface is built using RESTful APIs, allowing for the receipt of applicant data. The acronym “RESTful APIs” stands for Representational State Transfer Application Programming Interfaces. REST, which stands for Representational State Transfer, is an architectural style that defines a set of constraints for designing networked applications. RESTful APIs are web services that adhere to these principles and use the HTTP protocol to enable communication between different software systems. RESTful APIs are based on a client-server model, where the client makes requests to the server, and the server responds with the requested data or performs the requested actions. These APIs are stateless, meaning that each request from the client contains all the necessary information for the server to understand and process it. RESTful APIs typically use standard HTTP methods such as GET, POST, PUT, and DELETE to perform different operations on resources. These resources are represented by URLs (Uniform Resource Locators) known as endpoints, which the client can interact with. The API responds to the client's requests with data in a specific format, commonly JSON (JavaScript Object Notation) or XML (extensible Markup Language). The design principles of RESTful APIs emphasize scalability, simplicity, and interoperability. By using standard HTTP methods and following a resource-oriented approach, these APIs allow developers to build loosely coupled systems that can be easily extended, modified, and integrated with other applications. It would utilize a JSON (JavaScript Object Notation) format for data interchange, as JSON is lightweight and easy to parse. These APIs would be programmed to handle HTTP methods like POST and GET for data reception and retrieval respectively. In some embodiments, data storage of the invention utilizes a database management system (DBMS) like PostgreSQL or MongoDB for maintaining conflict of interest (COI) datasets. This DBMS is programmed with SQL or NoSQL queries to retrieve, store, and manipulate data.

The intelligence engine is the core of the system's ability to perform complex analyses. In some embodiments, the intelligence engine is implemented using machine learning libraries in Python such as TensorFlow or Scikit-Learn. In some embodiments, the intelligence engine creates a connection to a backend data engine (the DBMS) to retrieve the COI datasets. This engine parses incoming applicant data and performs a detailed analysis against the COI datasets. In some embodiments, this comparison is achieved by using a machine learning model that can identify complex patterns indicating quantitative probability potential.

It is understood that potential conflict identification may done by the model through a classification algorithm such as Random Forest or Support Vector Machine (SVM). In some embodiments, this algorithm compares the features of the applicant data with those in the COI datasets to predict potential conflicts. One of ordinary skill will appreciate that after the potential conflicts have been identified, they may be validated using stochastic metrics. This could be implemented using probability density functions and statistical hypothesis testing methods. One of ordinary skill in the art will appreciate that probability density functions (PDFs) and statistical hypothesis testing are two fundamental methods used in statistics and probability theory. A probability density function is a statistical expression that defines a probability distribution for a continuous random variable as opposed to a discrete random variable. Common examples of PDFs include the normal (Gaussian) distribution, exponential distribution, and the uniform distribution. These functions and distributions are used to calculate the probability of a random variable falling within a certain range of values.

One of ordinary skill in the art will appreciate that hypothesis testing is a method used to make decisions or draw conclusions about a population based on a sample of data. Common examples of statistical hypothesis testing methods include the t-test, chi-squared test, and the ANOVA (Analysis of Variance) test. These methods often involve the calculation of a test statistic, comparison of the test statistic to a critical value, and the making of a decision to accept or reject the null hypothesis. In some embodiments, the system might process applicant data and identify potential conflicts of interest first by receiving applicant data and performing an intelligence engine analysis. In some embodiments, an applicant submits their application for a position within a company. This information, which could include the applicant's employment history, personal connections, investment history, or the like, is sent to the system via a communication interface. The intelligence engine retrieves the applicant data and performs a detailed analysis against the COI datasets stored in the backend data engine. This comparison process involves the use of a machine learning model, which identifies potential conflicts by comparing the applicant's data against known conflict patterns in the COI datasets.

The intelligence engine then applies PDFs to the output of the machine learning model to estimate the probability of potential conflicts. For example, if the machine learning model flags a potential conflict based on the applicant's employment history and the company's existing relationships, a PDF might be applied to estimate the likelihood that this potential conflict could lead to an actual conflict of interest. The rules engine then references a policy database and validates these potential conflicts using statistical hypothesis testing. For instance, it might use a chi-squared test to determine whether the distribution of potential conflicts identified aligns with what would be expected based on the COI datasets. If the p-value obtained from this test is below a predetermined threshold (e.g., 0.05, or the like), the system would conclude that there's significant evidence to suggest a potential conflict of interest. In some embodiments, the rules engine, which could be implemented with a language like Prolog or using a Python-based rules engine like Pyke or PyCLIPS, calculates a quantifiable probability metric. This metric might be a score from 0 to 100, where higher scores indicate higher probability. These probability scores would be determined based on the severity of the potential conflict, the relevance to the organization or individual, and any historical data that may be applicable.

An intelligence engine plays a vital role in calculating the statistical confidence of the probability score. This process begins with the calculation of the probability metric, which may be referred to herein as a Probability Ratio (RR), which represents the extent of potential loss or opportunity. The RR is calculated by dividing the number of possible matches by the total number of Conflict of Interest (COI) potentials. If the RR is low, an automated or intelligent tolerance, denoted as (+/−T), is added to the weighted applicant points of overlap. The system then re-iterates over the COI repository, examining the revised Probability Ratio (RR+) value. This process continues until the ratio of T to RR approaches a constant value. At this point, the degree of insignificance between RR+ and RR provides a higher confidence score (CS) on the likelihood of a COI.

Subsequently, the system calculates the COI Impact Ratio (IR), which accounts for the financial effect of the candidate. This ratio is computed by dividing the Total Cost of Ownership (TCO) by the aggregate historical COI impact. Following the computation of RR and IR, the system calculates the Net Probability Score (NP). This score provides a comprehensive view of uncertainty, coupled with the potential positive or negative impacts. It is calculated by multiplying the RR by the IR and annotated with the CS to indicate the level of confidence in decision-making. As the analytics engine, encompassing both intelligence engine and the and COI workflow, continues to evolve, it leads to a higher confidence level in the Net Probability Score (NP) for any given applicant. This process ensures a thorough and systematic approach to identifying potential conflicts of interest, and mitigating probabilities associated with new hires or changes within the organization.

Following validation, the rules engine calculates a probability metric, taking into consideration both organizational and individual perspectives. Based on this probability metric, a recommendation would be generated. For instance, if the probability score is above a certain threshold, say 80, the system might recommend not proceeding with the applicant. Conversely, if the probability score is below the threshold, the system might recommend further assessment or approval. If the probability score is above a certain threshold, the system generates a recommendation not to proceed with the applicant. The generated recommendation is then sent to a user interface of a user device, in some regards this may be an external user device or an internal user device, which displays the recommendation to a human user. This could be a hiring manager or a member of the HR department, who can then take the appropriate action based on the recommendation. In other embodiments, the result may be displayed to the applicant in the same or similar manner for transparency purposes. In this way, the system offers increased transparency in hiring decisions versus conventional approaches, and acts as confirmation that the overall process is fair and based on in-depth objective analysis as opposed to subjective feelings of an interviewer or resume reviewer. This comprehensive process allows the system to intelligently analyze and interpret applicant data, provide a quantifiable measure of potential conflict probability, and generate actionable recommendations.

The user interface, built using frontend languages like HTML, CSS, and JavaScript, would display the recommendation. The frontend could use a JavaScript framework such as React.js or Vue.js to create a responsive and dynamic user interface. The interface would make a GET request to the server and display the returned data (the recommendation) to the user. It could display the potential conflict, the probability score, and the recommended course of action.

The system's multifaceted nature facilitates communication with both end-users and other systems, utilizing an API to transfer outputs from the intelligent response system. By granting access to the system's decisions, recommendations, and conclusions, it enables diverse usage, as the receiving systems can present the information as is or merged with their own data. Ultimately, one key aspect of the system's value lies in its versatile outputs which can be accessed via the user interface or an API, broadening the scope of potential recipients and highlighting its adaptability and extensive reach.

What is more, the present disclosure provides a technical solution to a technical problem. As described herein, the technical problem includes the challenge of effectively identifying potential conflicts of interest (COI) during the initial verification of applicants, potential vendors, partners, employees, or investors, using traditional, often manual, methods. The problem also extends to efficiently assessing the probability and impact of these conflicts for both the organization and the individuals involved, given the vast and evolving datasets related to COI. The technical solution presented herein allows for automated, intelligent analysis of network interaction data for identifying conflicts. The solution uses a uniquely designed intelligent engine that connects to backend data engines, performing specific analyses to assess various relationship domains using a probability and impact-based approach. The system's rules engine operates in the background, matching applicant data with potential COI, and validates these matches using stochastic metrics. The system then generates actionable recommendations based on this comprehensive probability analysis.

In particular, this system is an improvement over existing solutions to the problem of conflict of interest identification and analysis. It performs the analysis with fewer steps, reducing the amount of computing resources required, such as processing, storage, and network resources. It provides a more accurate solution by leveraging machine learning and statistical methods, reducing the number of resources required to remedy errors from less accurate solutions. The system removes manual input and waste from the process, thus improving speed and efficiency while conserving computing resources. It optimally determines the resources required to implement the solution, thus reducing network traffic and load on existing computing resources.

Furthermore, the technical solution described herein uses a rigorous, computerized process to perform specific tasks and activities, such as analyzing incoming applicant data and existing COI datasets, identifying potential conflicts of interest, validating identified conflicts using stochastic metrics, and generating recommendations based on the validated conflicts. These tasks were not previously performed or were performed in a less efficient manner. In specific implementations, the technical solution bypasses a series of steps previously implemented, such as manual cross-referencing and decision making, thus further conserving computing resources. As another critical aspect of the invention is that the automated nature of the solution significantly decreases subjective bias in conflict identification. By relying on machine learning algorithms and quantifiable metrics rather than individual judgement, it ensures a consistent, objective analysis of potential conflicts in every scenario. Furthermore, this automation mitigates the influence of human bias or error in decision-making, providing a fair and unbiased assessment of potential conflicts for all applicants, vendors, partners, or employees.

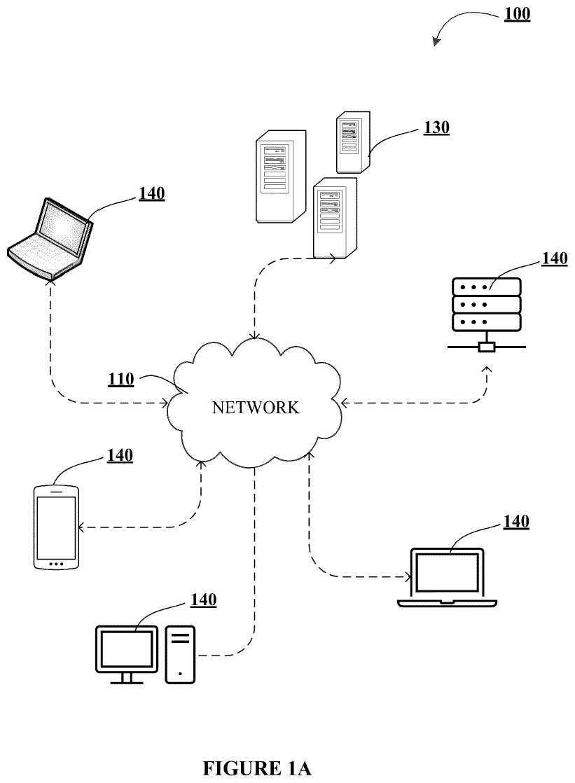

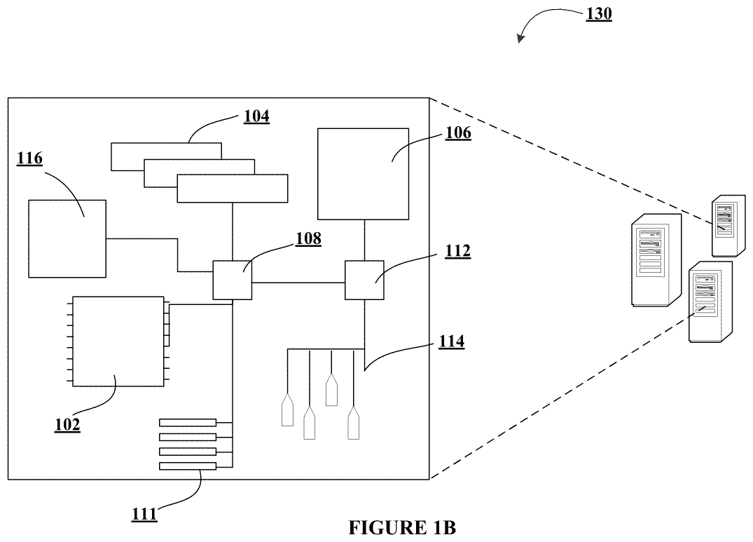

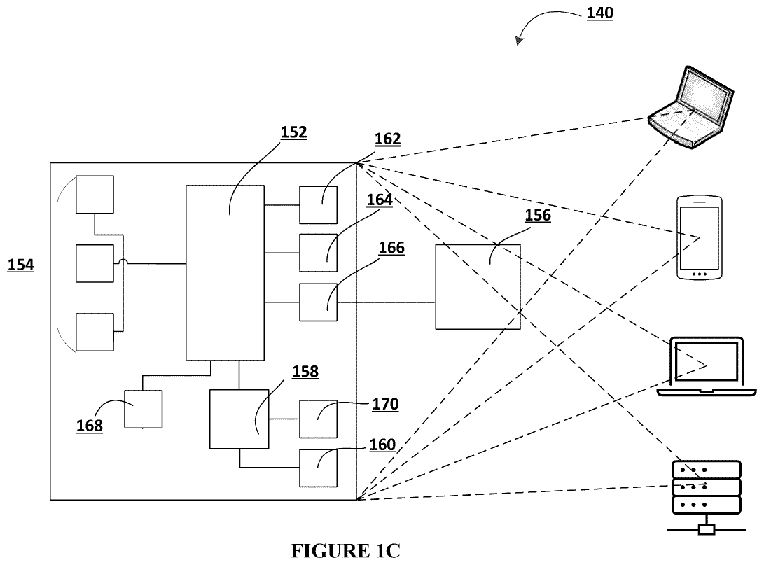

FIGS. 1A-1C illustrate technical components of an exemplary distributed computing environment 100 for machine engine analysis of network interaction data for identification of conflicts, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

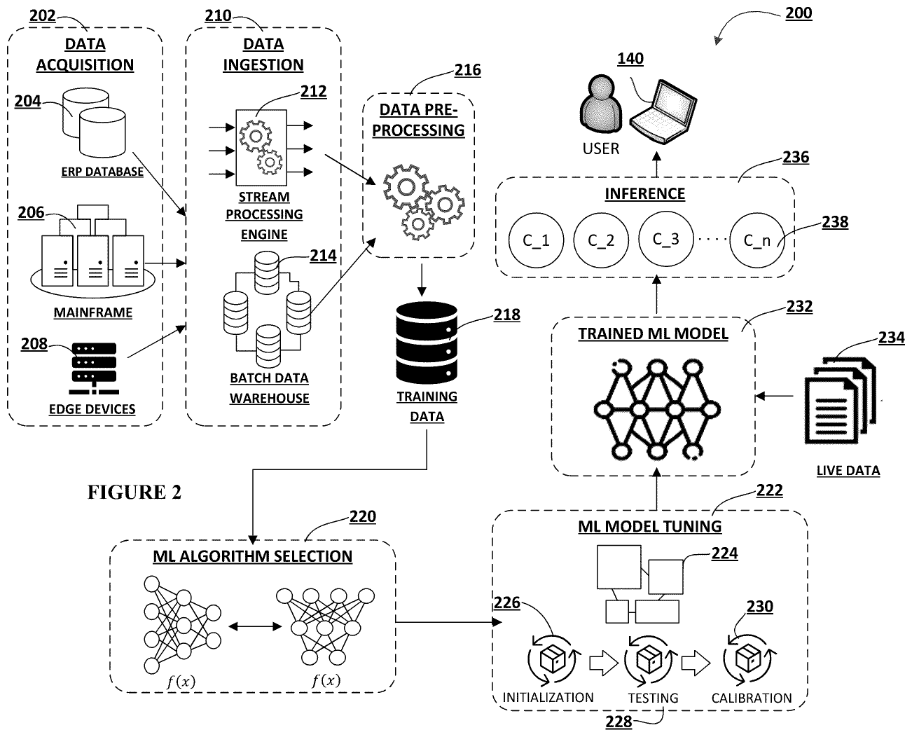

FIG. 2 illustrates an exemplary machine learning (ML) subsystem architecture 200, in accordance with an embodiment of the invention, which may be employed via the intelligence engine and the backend data engine of the invention in order to retrieve relevant data and perform necessary analyses. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes. It will be understood that the embodiment of the machine learning subsystem 200 illustrated in FIG. 2 is exemplary and that other embodiments may vary. As another example, in some embodiments, the machine learning subsystem 200 may include more, fewer, or different components.

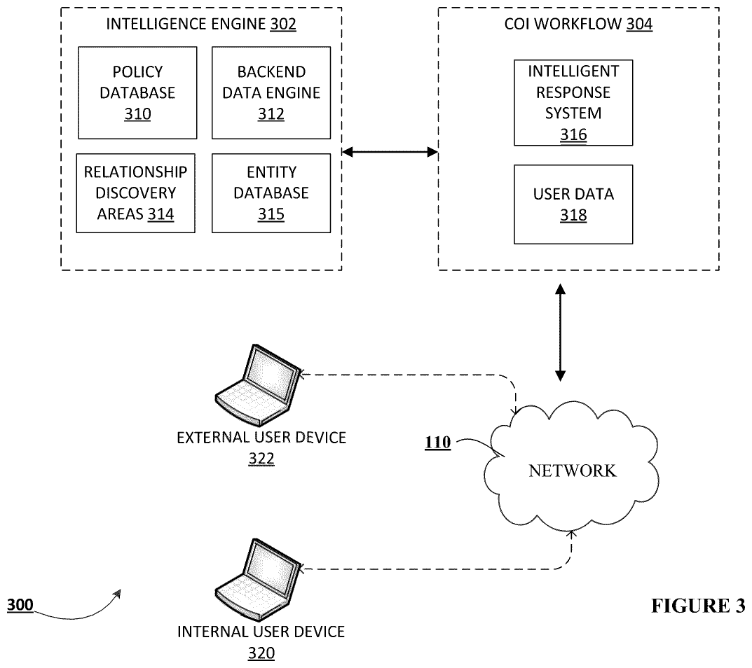

FIG. 3 illustrates a process flow for machine engine analysis of network interaction data for identification of conflicts, in accordance with an embodiment of the disclosure. The intelligence engine 302 serves as the central aspect of the system, with intricate interactions with the policy database 310, backend data engine 312, relationship discovery areas 314, and entity database 315. Each of these components is crucial in creating a robust, automated solution to identify potential conflicts of interest and assess the probability they pose.

The relationship discovery areas 314 encompass a broad spectrum of data sources such as investment regulations, employment applications, organization assignments, equal opportunity policies, and human resources (HR)/benefits associated information. The relationship discovery areas encompass multiple fields, which includes regulations surrounding investments, employment application processes, organizational assignments, policies related to equal opportunities, and aspects associated with human resources benefits.

In the domain of investment regulations, transactions involving restricted investments such as stocks, upcoming initial public offerings, or mergers and acquisitions are scrutinized. The system leverages business intelligence tools to investigate relationships among employees participating in similar transactions. This safeguard is in place to mitigate the probability of group dynamics or insider trading, which could potentially benefit a subset of employees disproportionately. If any such probabilities are identified, alternative investment paths that are safer from a business perspective are recommended.

In the context of employment applications, potential conflicts arise when an applicant is closely related to an existing employee who holds influence within the organization, or if the applicant had previous employment within the organization. Such scenarios could potentially disqualify an application. The system, in these cases, alerts the involved parties and offers recommendations such as different roles or deferred applications.

The area of organizational assignments deals with situations where a candidate's application is in conflict with an ongoing employment application, or if the candidate is vying for a position within a department where close relatives or significant contacts are already situated. These scenarios require reliance on internal business intelligence tools for probability assessment, which subsequently provide relevant recommendations to the applicant.

The area dealing with equal opportunity policies emphasizes the need for any new hire or job change to align with the organization's commitment to equal employment opportunity. If opportunities or placements diverge from this mandate, the system identifies such instances and communicates them to hiring managers to enable remedial actions.

Lastly, the human resources benefits aspect takes into consideration scenarios involving shared benefits, specifically spousal benefits. The system assesses potential synergies and cost savings arising from shared benefits such as coverage, assistance, relocation, or family and approved leave. It then recommends suitable compensation packages to HR business partners and hiring managers, with the objective of optimizing decisions in the company's interest.

Each of these areas provides valuable context to the applicant's data, allowing the intelligence engine to cross-reference and identify potential conflicts. For example, the intelligence engine might identify a potential conflict between an applicant's investment history, sourced from the relationship discovery areas, and the investment regulations of the entity. While this is only one embodiment of a conflict that may be identified by the system, it is described herein as an exemplary model for how the machine learning engine of the intelligence engine may be trained and utilized. It is understood that the intelligence engine may be used for other embodiments of potential conflict identification as well. In order to program a machine learning engine such as the intelligence engine 310 to identify a potential conflict between an applicant's investment history and the investment regulations of an entity, one of ordinary skill, such as a developer or AI specialist, must set up a process that involves data preprocessing, model training, evaluation, and inference.

Firstly, data preprocessing is necessary to transform raw data into a format that can be ingested by the machine learning algorithm. In this case, the applicant's investment history might be structured data such as stock ownership, financial transactions, or company affiliations. These data points would be extracted from the relationship discovery areas 314, which could include various financial databases or public records. Similarly, the investment regulations of the entity would be extracted from the policy database 310, transformed into a structured format, and used as rules or constraints within the machine learning model.

Once the data is preprocessed, the machine learning model can be trained. The model could be based on a classification algorithm like a Support Vector Machine (SVM), a Decision Tree, or a Neural Network. The goal of the model is to predict whether a given set of investment history data points conflicts with the rules defined by the entity's investment regulations. The training process involves feeding the model with labeled data, i.e., historical examples of conflict and non-conflict scenarios, and iteratively adjusting the model's parameters to minimize prediction errors.

After training, the model is evaluated using a separate set of labeled data, not used in the training phase. This step provides insights into how well the model generalizes to unseen data and its accuracy, precision, recall, and other performance metrics. Once the model is trained and evaluated, it can be used for inference. The intelligence engine 302 takes in a new applicant's investment history as input, preprocesses it into the required format, and feeds it into the trained model. The model then outputs a prediction—in this case, whether there is a potential conflict of interest or not. If a potential conflict is identified, the system could trigger the rules engine to validate the conflict using stochastic metrics and then generate a recommendation. In addition to the initial setup, a machine learning system should be regularly updated to reflect the latest data and trends. Therefore, the model's performance needs to be monitored, and the model may need to be retrained periodically with new data. In some embodiments, this could be handled by a separate component of the intelligence engine 302 dedicated to model maintenance and updating.

One of ordinary skill in the art will appreciate that implementing this process typically requires expertise in machine learning and programming languages like Python, which has extensive libraries for data science and machine learning such as Pandas, NumPy, and Scikit-Learn. It may also involve use of a database management system to store and retrieve the applicant data and investment regulations, and a web server or API to enable interaction with the user interface. The policy database 310 comprises entity policies around hiring. These policies are unique to each organization and provide a lens through which the applicant's data is assessed. The intelligence engine 302 utilizes these policies to guide its analysis and generate its recommendations. It can identify areas where the applicant's data might conflict with the entity's hiring policies and predict how these conflicts could impact the entity's probability score.

The backend data engine 312 is responsible for retrieving a multitude of data from the COI repository, including information about current and past employees, as well as entity data. The applicant data sourced from this engine might comprise resumes, application forms, background checks, employer references, and transcripts. This comprehensive dataset allows the intelligence engine 302 to draw on a wealth of information during its analysis. For example, in some embodiments, it might identify potential conflicts between the applicant's previous employment, as indicated on their resume, and the entity's past or current employees.

The intelligence engine 302 then uses all these interactions to generate recommendations for probability management, policy compliance, and political correctness. These recommendations are based on a complex interplay of factors, including the potential conflicts identified, the associated probabilities calculated, the entity's policies, and the broader context provided by the relationship discovery areas. In providing these recommendations, the system offers a highly comprehensive and unbiased approach to conflict of interest identification, delivering value to both the entity and the applicants involved.

In summary, the intelligence engine 302, in conjunction with the policy database 310, backend data engine 312, relationship discovery areas 314, and entity database 315, forms an intricate, efficient, and unbiased system for identifying potential conflicts of interest and managing associated probabilities. By incorporating extensive datasets and providing automated recommendations, this system significantly enhances the decision-making process in hiring and other similar scenarios.

Moving further in FIG. 3, the process flow 300 also includes COI workflow 304, which comprises the intelligent response system 316, and user data 318. The COI workflow 304 communicates over network 110 with external user device 322, which may belong to an applicant, or the like, and internal user device 320, which may be accessed by a hiring manager, or the like, in order to transmit and display information related to the decisions, recommendations, and conclusions output by the intelligence engine 302.

The intelligence engine 302 plays a vital role in calculating the statistical confidence of the probability score. This process begins with the calculation of the Probability Ratio (RR), which represents the extent of potential loss or opportunity. The RR is calculated by dividing the number of possible matches by the total number of Conflict of Interest (COI) instances. If the RR is low, an automated or intelligent tolerance, denoted as (+/−T), is added to the weighted applicant points of overlap. The system then re-iterates over the COI repository, examining the revised Probability Ratio (RR+) value. This process continues until the ratio of T to RR approaches a constant value. At this point, the degree of insignificance between RR+ and RR provides a higher confidence score (CS) on the likelihood of a COI.

Subsequently, the system calculates the COI Impact Ratio (IR), which accounts for the financial effect of the candidate. This ratio is computed by dividing the Total Cost of Ownership (TCO) by the aggregate historical COI impact. Following the computation of RR and IR, the system calculates the Net Probability Score (NP). This score provides a comprehensive view of uncertainty, coupled with the potential positive or negative impacts. It is calculated by multiplying the RR by the IR and annotated with the CS to indicate the level of confidence in decision-making. As the analytics engine, encompassing both intelligence engine 302 and the and COI workflow 304, continues to evolve, it leads to a higher confidence level in the Net Probability Score (NP) for any given applicant. This process ensures a thorough and systematic approach to identifying potential conflicts of interest, and mitigating probabilities associated with new hires or changes within the organization.

The COI workflow 304 serves as an integral part of the process flow 300, acting as a bridge between the intelligence engine 302 and the end-users who engage with the system. Its essential function is to facilitate effective and seamless communication of the decisions, recommendations, and conclusions generated by the intelligence engine 302. It achieves this through its two key components: the intelligent response system 316 and the user data 318. The intelligent response system 316 is a dynamic component that takes the output from the intelligence engine 302 and translates it into digestible and actionable insights. These insights are tailored to the specific needs of the end-users, whether they are applicants or hiring managers. For example, an applicant might receive a personalized report outlining potential conflicts of interest identified during the assessment, with recommendations on how to mitigate these conflicts. On the other hand, a hiring manager might receive a detailed analysis of the overall probability posed by the applicant, along with suggested actions to manage this probability. These varying insights underscore the system's capability to customize its outputs based on the user, effectively providing each user with relevant and valuable information.

The user data 318 refers to the personalized information specific to each user. This could include the applicant's personal details, background information, application materials, and even user preferences. For the hiring manager, the user data could contain the specific hiring needs, the manager's preference in terms of probability tolerance, and previous hiring decisions. The user data is used to tailor the system's outputs, ensuring that the insights generated by the intelligent response system 316 are relevant and specific to each user. This interaction between the COI workflow 304 and the user devices, which may be either external (322) like an applicant's device or internal (320) like a hiring manager's device, ensures a smooth transfer of information. The network 110 serves as the communication pathway, transmitting the information generated by the intelligent response system 316 to the appropriate user device. This could involve sending the report to an applicant outlining the potential conflicts of interest or presenting the hiring manager with a probability analysis on their device.

The versatility of the system allows it to interact not only with end-users but also with other systems, such as internal systems or third-party systems. This interaction takes advantage of an application programming interface (API) to provide or make available the output from the intelligent response system 316. It gives other systems access to the decisions, recommendations, and conclusions generated by the intelligence engine 302. Once received, these systems have the option to display the information in its original form or in combination with their own data. This potential for information integration enhances the usefulness and relevance of the output to a broader array of recipients. The output is no longer confined to the individual users but also extends to other systems, which further underscores the adaptability and expansive reach of the system. A key advantage of the system lies in the outputs it generates and the various ways these outputs can be consumed, either via either the provided user interface display for end-users, or through an API to an internal system or another system.

In sum, the COI workflow 304, comprising the intelligent response system 316 and user data 318, plays a pivotal role in the process flow 300. It not only translates the output of the intelligence engine 302 into actionable insights but also ensures these insights are customized to each user and delivered efficiently via the network 110. This intricate interaction between various components and user devices results in a comprehensive and user-centric system for managing conflicts of interest.

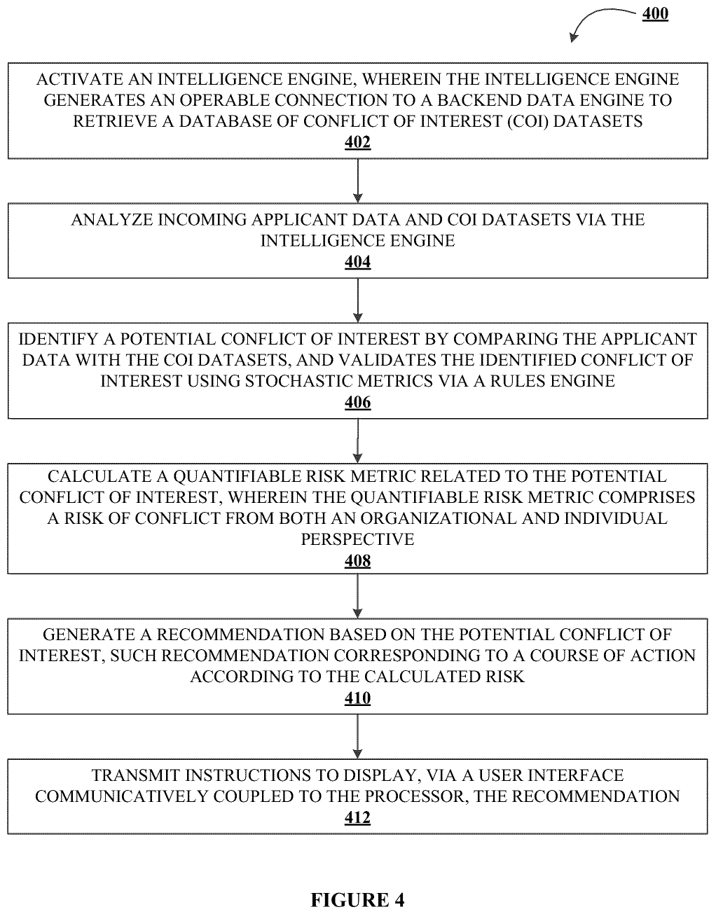

FIG. 4 illustrates a comprehensive process flow for machine engine analysis of network interaction data for identification of conflicts, presenting a sequence of steps that ensure efficient and accurate detection and management of conflicts of interest. The process begins at block 402 with the activation of the intelligence engine. The intelligence engine serves as the cornerstone of the system, responsible for initiating the conflict analysis process. It establishes a connection with a backend data engine, which houses the repository of conflict of interest (COI) datasets. This collection might include data on past and present employees, industry-specific rules on conflicts, and past conflict instances within the organization or sector. This operable connection facilitates real-time access to and exchange of data between the intelligence engine and the backend data engine.

Following the initiation, the process proceeds to block 404 where the intelligence engine starts analyzing the incoming applicant data and the retrieved COI datasets. The applicant data, such as resumes, application forms, and background checks, is processed and matched against the COI datasets. This step may involve the use of sophisticated machine learning algorithms to detect patterns and correlations that could signal a potential conflict of interest. The system then transitions to block 406, where it identifies potential conflicts by comparing the applicant data with the COI datasets. It utilizes a rules engine to validate the identified conflict using stochastic metrics, which offer probabilistic validation of the conflict. This step emphasizes the system's ability to apply a statistical, data-driven approach to conflict validation, increasing the accuracy and reliability of conflict detection. Next, at block 408, the system calculates a quantifiable probability metric associated with the potential conflict. This probability metric considers the potential implications from both an organizational and an individual perspective. It could be based on a wide array of factors, including the severity of the potential conflict, its possible impact on organizational operations or reputation, and the individual's role within the organization.

Following the probability calculation, the system generates a recommendation based on the potential conflict at block 410. This recommendation proposes a course of action derived from the calculated probability metric. This could range from immediate resolution steps, such as a change in the applicant's role or responsibilities, to longer-term strategies like policy amendments to better manage such conflicts in the future. Lastly, at block 412, the system transmits instructions to display the generated recommendation on a user interface. The interface is communicatively coupled to the processor, ensuring real-time delivery of the system's outputs. This could involve a detailed report outlining the potential conflict, the associated probability, and the recommended course of action, ensuring that users, such as HR professionals or hiring managers, have comprehensive information to make informed decisions. Overall, this detailed process flow presents a robust and intelligent solution for conflict of interest detection and management, bringing together advanced machine learning techniques, rigorous data analysis, and intuitive user communication to help organizations mitigate potential conflicts effectively and proactively.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for machine engine analysis of network interaction data, the system comprising:
a processing device;
a non-transitory storage device containing instructions when executed by the processing device, causes the processing device to perform the steps of:
activate an intelligence engine, wherein the intelligence engine generates an operable connection to a backend data engine to retrieve a database of conflict of interest (COI) datasets;
analyze incoming applicant data and COI datasets via the intelligence engine;
identify a potential conflict of interest by comparing the applicant data with the COI datasets, and validates the identified conflict of interest using stochastic metrics via a rules engine;
calculate a quantifiable probability metric related to the potential conflict of interest, wherein the quantifiable probability metric comprises a probability of conflict from both an organizational and individual perspective;
generate a recommendation based on the potential conflict of interest, such recommendation corresponding to a course of action according to the calculated probability; and
transmit instructions to deliver, via an application programming interface (API), the recommendation.

2. The system of claim 1, wherein the intelligence engine utilizes machine learning algorithms to analyze the incoming applicant data and the COI datasets.

3. The system of claim 1, wherein the backend data engine further comprises current and past employee data, industry-specific conflict rules, and past conflict instances.

4. The system of claim 1, wherein the stochastic metrics used for validating potential conflicts of interest are derived using probability density functions and statistical hypothesis testing methods.

5. The system of claim 1, wherein the quantifiable probability metric is calculated based on factors including severity of the potential conflict, potential impact on organizational operations or reputation, and the individual's role within the organization.

6. The system of claim 1, wherein the generated recommendation includes immediate resolution steps or long-term strategic actions such as amendments to organization policies.

7. The system of claim 1, wherein delivering, via the API, the recommendation, further comprises displaying, via a user interface, a detailed output including the potential conflict, the associated probability, and the recommended course of action.

8. A computer program product for machine engine analysis of network interaction data, the computer program product comprising a non-transitory computer-readable medium comprising code causing an apparatus to:
activate an intelligence engine, wherein the intelligence engine generates an operable connection to a backend data engine to retrieve a database of conflict of interest (COI) datasets;
analyze incoming applicant data and COI datasets via the intelligence engine;
identify a potential conflict of interest by comparing the applicant data with the COI datasets, and validates the identified conflict of interest using stochastic metrics via a rules engine;
calculate a quantifiable probability metric related to the potential conflict of interest, wherein the quantifiable probability metric comprises a probability of conflict from both an organizational and individual perspective;
generate a recommendation based on the potential conflict of interest, such recommendation corresponding to a course of action according to the calculated probability; and
transmit instructions deliver, via an application programming interface (API), the recommendation.

9. The computer program product of claim 8, wherein the intelligence engine utilizes machine learning algorithms to analyze the incoming applicant data and the COI datasets.

10. The computer program product of claim 8, wherein the backend data engine further comprises current and past employee data, industry-specific conflict rules, and past conflict instances.

11. The computer program product of claim 8, wherein the stochastic metrics used for validating potential conflicts of interest are derived using probability density functions and statistical hypothesis testing methods.

12. The computer program product of claim 8, wherein the quantifiable probability metric is calculated based on factors including severity of the potential conflict, potential impact on organizational operations or reputation, and the individual's role within the organization.

13. The computer program product of claim 8, wherein the generated recommendation includes immediate resolution steps or long-term strategic actions such as amendments to organization policies.

14. The computer program product of claim 8, wherein delivering, via the API, the recommendation, further comprises displaying, via a user interface, a detailed output including the potential conflict, the associated probability, and the recommended course of action.

15. A method for machine engine analysis of network interaction data, the method comprising:
activating an intelligence engine, wherein the intelligence engine generates an operable connection to a backend data engine to retrieve a database of conflict of interest (COI) datasets;
analyzing incoming applicant data and COI datasets via the intelligence engine;
identifying a potential conflict of interest by comparing the applicant data with the COI datasets, and validates the identified conflict of interest using stochastic metrics via a rules engine;
calculating a quantifiable probability metric related to the potential conflict of interest, wherein the quantifiable probability metric comprises a probability of conflict from both an organizational and individual perspective;
generating a recommendation based on the potential conflict of interest, such recommendation corresponding to a course of action according to the calculated probability; and
transmitting instructions deliver, via an application programming interface (API), the recommendation.

16. The method of claim 15, wherein the intelligence engine utilizes machine learning algorithms to analyze the incoming applicant data and the COI datasets.

17. The method of claim 15, wherein the backend data engine further comprises current and past employee data, industry-specific conflict rules, and past conflict instances.

18. The method of claim 15, wherein the stochastic metrics used for validating potential conflicts of interest are derived using probability density functions and statistical hypothesis testing methods.

19. The method of claim 15, wherein the quantifiable probability metric is calculated based on factors including severity of the potential conflict, potential impact on organizational operations or reputation, and the individual's role within the organization.

20. The method of claim 15, wherein the generated recommendation includes immediate resolution steps or long-term strategic actions such as amendments to organization policies.
